(19) United States
(12) Patent Application Publication
(10) Pub. No.: US 2012/0126677 A1
(43) Pub. Date: May 24, 2012

(54) Device for movable furniture part, and piece of furniture

(75) Inventor: Jürgen Ahlfeld, Weissensberg (DE)

(73) Assignee: Grass GmbH, Hochst (AT)

(21) Appl. No.: 13/296,669

(22) Filed: Nov. 15, 2011

(30) Foreign Application Priority Data
Nov. 18, 2010 (DE) 20 2010 015 536.3

(51) Int. Cl. E05D 11/10; A47B 96/00

(52) U.S. Cl. 312/326; 16/319; 16/349

(57) ABSTRACT

The invention is a device for a movable furniture part, such as a door, shutter or drawer, that includes a first attachment part fitted on a basic structure and connected, via an articulation mechanism, to a second attachment part fitted on the movable furniture part that pivots the movable furniture part, and a damping device for damping the relative movement during pivoting of the movable furniture part. The damping device includes a damper housing and an internal part accommodated on the damper housing that are movable in relation to one another, where the damper housing or the internal part serves as a contact part which contacts, at least temporarily, a portion of the device during pivoting of the furniture part. An adjusting arrangement adjusts the damping. The adjusting arrangement is mounted to a predefined fitting position that is changeable and the damping device is secured in the predefined fitting position.

### BACKGROUND OF THE INVENTION

Pieces of furniture having a furniture part, e.g. a door, shutter or drawer, which is accommodated in a movable manner on a basic furniture structure and can be pivoted via an articulation mechanism, or displaced via a sliding mechanism, are known. A first attachment part of a guide means here is provided on the basic structure and a second attachment part of the guide means is provided on the movable furniture part. The guide means may comprise, for example, a hinge with an articulation mechanism or a pull-out guide with a sliding mechanism.

In the mounted state of the guide means, it is possible to provide a damping device for damping the relative movement of device parts or attachment parts during pivoting or displacement of the movable furniture part. As a result, it is also the case that the movement of the movable furniture part is damped by the damping device and/or braked or damped for example over a final section prior to a closed position of the movable furniture part relative to the basic structure being reached. It is thus possible to avoid undesired impact noise and rebound movements of the furniture part, and also damage to the piece of furniture.

The damping device, which comprises, for example, a fluid damper or a gas or liquid damper, has, in particular, components such as a basic body with a damper housing, together with an internal part, present thereon, wherein the damper housing and internal part, during pivoting or displacement of the furniture part, during operation of the damping device, can be moved in a defined manner relative to one another, overcoming a resistance in the process. For example, the internal part may comprise a piston arrangement which can be displaced back and forth in a damper housing designed as a cylinder. It is possible here either for the damper housing or for the internal part to serve as a contact part which, for damping purposes, comes into contact, at least temporarily, with a portion of the device which can be moved during pivoting or displacement of the furniture part. As contact is established, the operation of damping the movement of the relevant parts of the device, and thus of the movable furniture part, is initiated. An adjusting arrangement may possibly be present in order to act on the damping device with respect to a damping action provided thereby.

### SUMMARY OF THE INVENTION

It is an object of the present invention to improve pieces of furniture and devices of the type mentioned in the introduction with respect to the damping device.

The invention proceeds from a device for a movable furniture part, in particular for a door, shutter or drawer, wherein the device has a first attachment part, which can be fitted on a basic structure and is connected, via an articulation mechanism, to a second attachment part, which can be fitted on the movable furniture part and is intended for pivoting the movable furniture part. In the mounted state of the device, for the purpose of damping the relative movement of parts of the device during pivoting of the movable furniture part, there is a damping device present, which comprises a damper housing and an internal part accommodated on the damper housing, the latter and the internal part being movable in relation to one another. The damper housing or the internal part serves as a contact part which, for damping purposes, comes into contact, at least temporarily, with a portion of the device which can be moved during pivoting of the furniture part, and there is an adjusting arrangement provided, it being possible for this to adjust the damping provided by the damping device. The device may be, in particular, a hinge or a pull-out or rail guide or a combination thereof.

Instead of the articulation mechanism, it is also possible to form a sliding mechanism for displacing the movable furniture part, or a combination of an articulation mechanism and a sliding mechanism for pivoting and/or displacing the movable furniture part.

A first main aspect of the invention is that the adjusting arrangement is designed, for adjusting desired damping, to predefine a fitting position of the damping device in the mounted state on the device in a manner which allows this position to be changed, wherein the damping device is secured in the predefined fitting position on the device. This means that, before and following a change to the fitting position of the damping device, the fitting position is maintained during operation. The existing capacity for the damper housing and internal part to move relative to one another remains unaffected thereby. The damping device can be secured on the device, in particular, in a predefinable mounting position on the device, or on the relevant attachment part on which the damping device is present. Thus, for example, the basic body of the damping device is fastened, in particular in a releasable manner, on the attachment part, for example plugged or clipped thereon. The damping device is present preferably on the second attachment part.

The hinge or the pull-out guide with the damping device has, in particular, a component which can be fitted on the hinge or the pull-out guide, or is usually separate, and forms the damping device with the constituent parts thereof. The damping is advantageously adjusted using the proposed arrangement, since straightforward adjustment is realized by the change in position of the damping device on the device. In particular, there is no change here to the internal operating mechanism of the damping device, that is to say the characteristics of the movement of the inner part and damper housing relative to one another. Internal operating characteristics of the damper, once predefined by the production of the damping device, remain unaffected by the changed fitting position. The damper is not affected, which is advantageous in respect of the reliability and the service life of the damping device. This is because the interaction between the damper housing and internal part is realized, in particular, via small-sized structures. Such dampers are, for example, fluid dampers with sensitive sealing and/or guide arrangements.

The damping device is not changed, for example, with respect to a possible displacement distance or travel of the internal part relative to the damper housing; rather, all that changes is the fitting position of the damping device on the device.

This advantageously makes it possible for the damping device, in comparison with prior-art damping devices of the same type, to be designed in a less complicated and/or more space-saving manner and/or with smaller dimensions.

A further main aspect of the invention is that the adjusting arrangement is designed such that a position of a contact element of a contact location of the device, via which the device, for damping purposes, can be brought into abutment, temporarily, with the contact part of the damping device, can be predefined in a manner which allows it to be displaced in relation to the rest of the device. It is thus possible for the damping action to be adjusted, and/or influenced, on those parts of the device which do not belong to the damping device. The damping device is not, or need not, be affected. It is therefore the case, so to speak, that a contour of the contact location of the device is changed, which has an effect on the interaction between the contact location and contact part of the damper, and thus influences the damping. The contact element of the contact location can be adjusted, in particular, in a stepless manner in relation to the rest of the portions of the device. The point in time and/or duration of the damping, and/or the course of interaction between the contact element and the contact part during the damping operation, depends on the contour of the contact location.

The contact element may be adjusted, in particular, in distance from the contact part of the damping device, that is to say it may be adjusted closer to the contact part or further away from the contact part. If it is adjusted closer, the damping action commences, for example, earlier or can act over a relatively long movement phase of the furniture-part movement, or, if it is adjusted further away, the damping action is later to commence or the contact element and the contact part remain longer without contact. This concerns the damped movement direction, in particular closing movement; the other direction or opening direction remains unaffected by the damping device. When the furniture part moves back, that is to say following the closing movement, during opening, the contact element accordingly breaks contact again from the contact part of the damping device as soon as it has reached its fully extended standby position and is ready for the next damping operation upon renewed closure of the furniture part.

The adjustment, during a dampable movement of the movable furniture part, predefines the movement, or the relative position of those parts of the hinge or of the pull-out means which can be moved in relation to one another, at which the contact element and the contact part come into contact in a movement direction of the movable furniture part. As contact is established between the contact element and the contact part, the damping action commences.

Furthermore, it is proposed that the position of the contact element or the contact location of the device is predefined via control means which comprise a screw arrangement. Using a screw arrangement, the position of the contact element can be changed straightforwardly and possibly without the aid of an adjusting tool, for example manually. For example, a head of a screw of the screw arrangement may form the contact element. It is advantageously possible for the position of the contact location to be adjusted in a stepless manner.

As an alternative, it may also be advantageous to provide a spindle arrangement, a worm arrangement, an eccentric arrangement or a latching arrangement.

It may also be advantageous to have an arrangement with an oblique plane, for example in the manner of a sloping-surface transmission, for adjusting the contact location.

It is also advantageous if the damping device is designed such that the position which the contact part assumes relative to the damping device in a standby position, in which the contact location of the device comes into abutment against the contact part, is maintained irrespective of the securable fitting position of the damping device on the device. This means that the damping device itself is not adjusted, for example with respect to its fitting position or a contact-part travel distance, which is covered by the contact part during a damping operation.

It is further advantageous if the damping device is designed such that a possible movement distance of the contact part established relative to other parts of the damping device is maintained irrespective of the securable fitting position of the damper housing on the device. This also results in a comparatively straightforward configuration of the damping device.

An advantageous modification of the subject matter of the invention is distinguished in that the damping device is configured such that it is possible to adjust a possible movement distance of the contact part established relative to other parts of the damping device.

This may possibly likewise be advantageous, the adjustment of a movement distance of the contact part relative to other parts of the damping device taking place straightforwardly for the purpose of adjusting the damping or damping action or damping duration.

Switch means, by way of which the damping device can be regulated, are advantageously provided. In particular, the damping device can be regulated such that, in one switching position, a damping action is established, that is to say can take effect, or alternatively, in another setting which can be established by the switch means, damping by means of the damping device is completely deactivated or prevented. No damping action takes place in the latter case. For this purpose, there is advantageously no need for the damping device to be removed. Conversely, it is possible at a later stage, without re-installation of the damping device being necessary beforehand, for the deactivated damping device present to be activated again.

The switch means are preferably configured for manual actuation. It is thus possible in a straightforward manner, and without using any tools, in particular by way of a handle, to actuate the switch means and thus either activate the damping device or switch it off altogether.

Moreover, it is advantageous if the damping device is positioned in a recessed region of an attachment part, in particular of a device cup. It is thus possible for the damping device to be accommodated advantageously, and in a space-saving manner, for example in a cup of a hinge, in particular without the relevant attachment part having to be changed in comparison with an arrangement without a damping device, since hinge cups usually have a free recessed volume in any case.

In an advantageous embodiment of the invention, the damping device comprises a cylinder component and a piston component with an extension, it being possible for these components to be moved in relation to one another during damping. Such cylinder/piston arrangements are small in size and have proven successful as damper arrangements or are commercially available as standard in different configurations.

It is also advantageous to provide spring means, which can subject the cylinder component or the piston component to a spring force which is active during the movement of the cylinder component and piston component relative to one another. Using a spring force, in accordance with an appropriate spring constant of the spring used, it is possible for loading peaks which occur during operation, in particular, briefly at the damping device during damping to be absorbed, in order to counteract, for example, damage or noise.

The invention also relates to a piece of furniture having a basic structure and a movable furniture part, in particular having a door, shutter or drawer, attached to the basic structure. According to the invention, one of the above-described devices is provided. The advantages explained above can thus be realized for a corresponding piece of furniture. The furniture part has, in particular, a hinge which allows a door or shutter to be pivoted relative to the basic structure.

### BRIEF DESCRIPTION OF THE DRAWINGS

Further advantages and features of the invention will be explained in more detail with reference to the exemplary embodiments shown in the figures, in which, specifically:

FIGS. 1 and 2 show an oblique plan view, in perspective, of part of a hinge according to the invention with a damping device, hinge parts being in two different positions relative to one another,

FIG. 3 shows a perspective view from beneath the arrangement according to FIG. 2,

FIG. 4 shows a perspective view, as seen obliquely from above, of the damping device present in the arrangement according to FIGS. 1 to 3, and

FIG. 5 shows a perspective view from beneath the damping device according to FIG. 4.

### DETAILED DESCRIPTION OF THE INVENTION

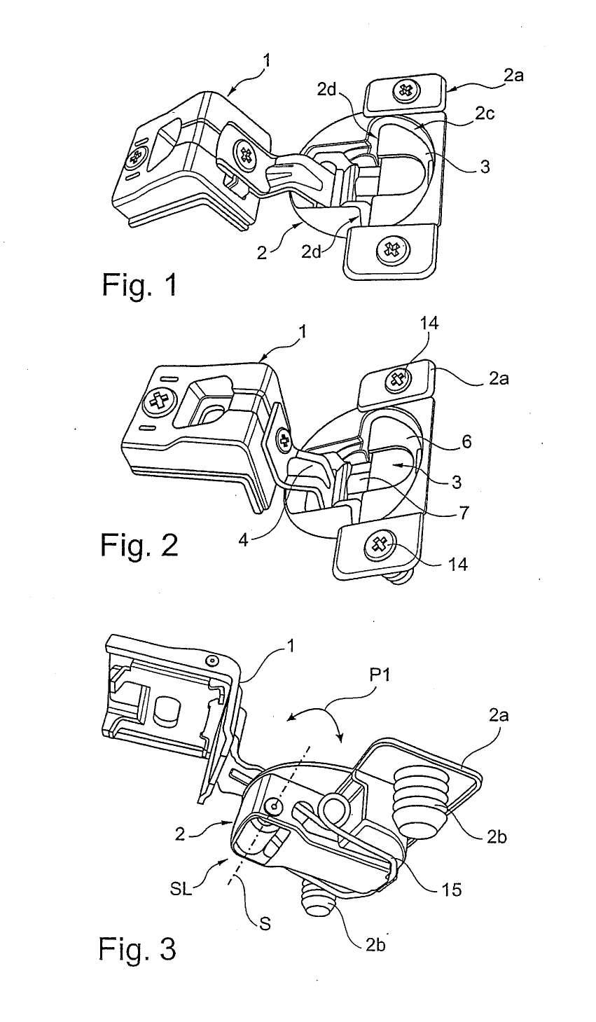

FIGS. 1 to 3 show part of a hinge according to the invention for a furniture part (not shown) which can be fitted in a pivotable manner on a basic furniture structure, wherein a first attachment part of the hinge, this part being designed for fitting on the basic furniture structure, is not illustrated. A hinge arm 1 of the hinge is connected to the first attachment part in the mounted state of the hinge, and therefore the hinge can be used to pivot the movable furniture part out of a closed position, in which the furniture part is closed relative to the basic furniture structure, into an open position, and back. The movable furniture part here is pivoted about a pivot axis S according to the double arrow P1. The pivot axis belongs to a pivot bearing SL of the hinge. The hinge arm 1 is connected in an articulated manner, via the pivot bearing SL, to the second attachment part, which can be secured on the movable furniture part and comprises a hinge cup 2 and a fastening flange 2a.

Those positions of the hinge parts in relation to one another which are shown in FIGS. 1 to 3 correspond, in the state in which the hinge is mounted on the piece of furniture, to a position in which the movable furniture part is partially open relative to the basic furniture structure; that is to say between a position in which the furniture part is fully closed in relation to the basic structure and a position in which it is fully open.

For mounting on the movable furniture part, the hinge cup 2 is inserted in a depression or mount, for example a blind hole, prepared in a correct position on the furniture part and is fixed in the correct position via two further bores, which are present to the sides of the blind hole and in which engage fastening stubs 2b which are present on the underside of the fastening flange 2a, by means of screws 14, which engage in the fastening stubs 2b from above.

In a recessed region in the hinge cup 2, this region being located opposite the pivot axis S, a base plate 6 of a damping device 3 is adapted to the semicircular shape of an inner wall of the depression of the hinge cup 2, and therefore the damping device 3 is inserted in the recessed region of the hinge cup 2. A semicircular outer portion of the base plate 6 here butts against an inner wall 2c of the hinge cup 2, this inner wall being semicircular in a view of the recessed hinge cup 2 from above. Following the arcuate inner wall 2c, two inwardly extending protrusions 2d are formed in the wall of the hinge cup 2, the damping device 3 being supported on each of these protrusions and thus being retained in a fixed position, with slight clamping action, in the hinge cup 2. On the underside, the damping device 3 sits on a base surface of the depression of the hinge cup 2. Accordingly, the damping device 3 can be inserted readily, e.g. by hand, with clamping action into the hinge cup 2 from above during production of the hinge.

A clip spring 15 also takes part, in particular as an automatic closing mechanism, in a pivoting movement of the furniture part, with the hinge in the mounted state, in order for the movable furniture part to be brought, under spring action, into a position in which it is closed against the basic structure, and for it to be retained in this position. This force, or an overall closing-movement force or the closing energy of the closing furniture part, which is pushed shut, possibly with force, by a user, is countered by the damping device 3 during closure of the furniture part, the damping device braking the closing movement of the furniture part over its final section.

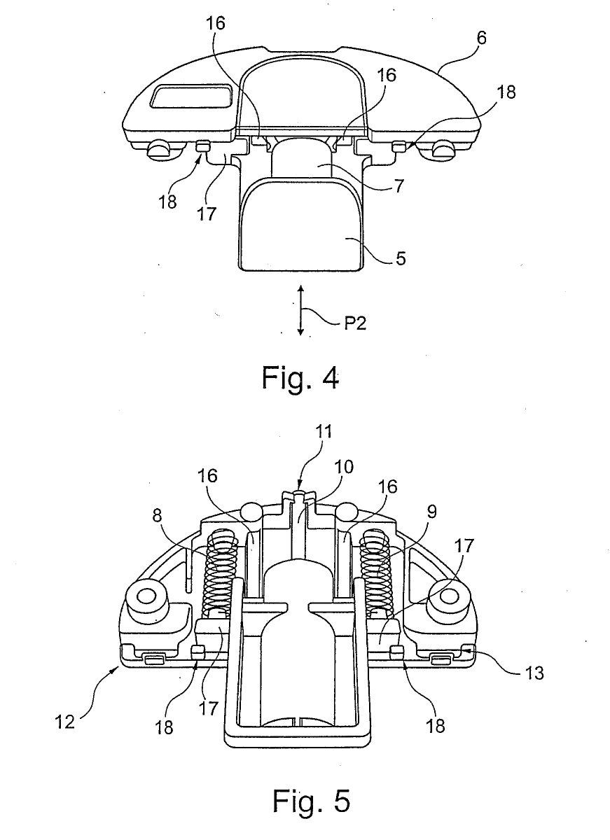

As the final section is reached during the closing movement of the movable furniture part, a bearing point 4 or a bearing region on the hinge arm 1, which is present in a fixed position in relation to the basic furniture structure, comes into contact with part of the hinge part which moves three-dimensionally during pivoting. The bearing point 4 comes into contact with a contact part of the damping device 3, wherein the contact part is formed on a damper housing 5 of the damping device 3. The damper housing 5 can be displaced back and forth relative to the base plate 6 of the damping device 3, according to double arrow P2 in FIG. 4, counter to a damping resistance, wherein FIGS. 4 and 5 show a position in which the damper housing 5 has been moved out in relation to the base plate 6. The damper housing 5 forms the front portion of a damper cylinder 7, which is guided on guide crosspieces 16 of the base plate 6.

In addition, the damper cylinder 7, biased via springs 8, 9, is retained in an extended stopping position according to FIGS. 4 and 5 in relation to the base plate 6, wherein noses 17 which project laterally from the damper cylinder 7 press against mechanical stops 18 on the base plate 6. During the damping operation, the damper cylinder 7 can be pushed inward, with the springs 8, 9 being compressed in the process, from its projecting position on the base plate 6. This additionally gives rise to a relative movement of a piston (not visible) which engages in an inner volume, or hollow volume, of the damper cylinder 7, has a piston rod 10 fixed on it and has its free end fixed on a piston-rod fixing means 11 on the base plate 6. The damper cylinder 7 and the piston, together with piston rod 10, act like a fluid damper or piston/cylinder damper known per se, and will therefore not be explained in any more detail.

FIG. 5 does not illustrate a control pin which can be fitted on the underside of the base plate 6, and can be inserted in a control-pin mount 12 or 13 which then secures the fully pushed-in damper cylinder 7 counter to the force of the springs 8 and 9. The damping action of the damping device 3 can thus be deactivated altogether as long as the control pin is inserted.

### LIST OF REFERENCE NUMERALS

1 Hinge arm
2 Hinge cup
2a Fastening flange
2b Fastening stub
2c Inner wall
2d Protrusion
3 Damping device
4 Bearing point
5 Damper housing
6 Base plate
7 Damper cylinder
8, 9 Spring
10 Piston rod
11 Piston-rod fixing means
12, 13 Control-pin mount
14 Screw
15 Clip spring
16 Guide crosspiece
17 Nose
18 Stop

1. A device for a movable furniture part, in particular for a door, shutter or drawer, comprising: a first attachment part, which is fitted on a basic structure and is connected, via an articulation mechanism, to a second attachment part, which is fitted on the movable furniture part and pivots the movable furniture part, and a damping device, wherein in the mounted state of the device, the damping device dampens the relative movement of parts of the device during pivoting of the movable furniture part, the damping device comprising a damper housing and an internal part accommodated on the damper housing, the damper housing and the internal part being movable in relation to one another, wherein one of the damper housing and the internal part serves as a contact part which, for damping purposes, comes into contact, at least temporarily, with a portion of the device which can be moved during pivoting of the furniture part, wherein an adjusting arrangement adjusts the damping provided by the damping device, wherein the adjusting arrangement adjusts the damping, using predefined fitting positions of the damping device in the mounted state on the device in a manner which allows the predefined fitting position of the damping device to be changed, and wherein the damping device is secured in the predefined fitting position on the device.

2. The device as claimed in claim 1, wherein in the adjusting arrangement a position of a contact element of a contact location of the device, via which the device, for damping purposes, can be brought into abutment, temporarily, with the contact part of the damping device, is predefined in a manner which allows it to be displaced in relation to the rest of the device.

3. The device as claimed in claim 2, wherein the position of the contact element of the contact location of the device is predefined via a control mechanism which comprises a screw arrangement.

4. The device as claimed in claim 1, wherein in the damping device a position which the contact part assumes relative to the damping device in a standby position, in which the contact location of the device comes into abutment against the contact part, is maintained irrespective of the securable predefined fitting position of the damping device on the device.

5. The device as claimed in claim 1, wherein in the damping device a movement distance of the contact part established relative to other parts of the damping device is maintained irrespective of the securable predefined fitting position of the damper housing on the device.

6. The device as claimed in claim 5, wherein the damping device adjusts a movement distance of the contact part established relative to further parts of the damping device.

7. The device as claimed in claim 1, further comprising a switch mechanism, by way of which the damping device is regulated.

8. The device as claimed in claim 7, wherein the switch mechanism is manually actuated.

9. The device as claimed in claim 1, wherein the damping device is positioned in a recessed region of an attachment part.

10. The device as claimed in claim 1, wherein the damping device further comprises a cylinder component and a piston component with an extension, and the cylinder component and the piston component are moved in relation to one another during damping.

11. The device as claimed in claim 10, further comprising a spring mechanism, wherein the spring mechanism subjects one of the cylinder component and the piston component to a spring force which is active during the movement of the cylinder component and piston component relative to one another.

12. A piece of furniture having a basic structure and a movable furniture part comprising a door and shutter that is attached to the basic structure, wherein a device as claimed in claim 1 is provided.

13. The device as claimed in claim 9, wherein the recessed region of an attachment part is a device cup.
